(19) United States
(12) Patent Application Publication
(10) Pub. No.: US 2023/0003419 A1
(43) Pub. Date: Jan. 5, 2023

(54) EXTERIOR CASE FOR HOT-WATER UNIT, AND HOT-WATER UNIT EQUIPPED WITH SAME

(71) Applicant: NORITZ CORPORATION, HYOGO (JP)

(72) Inventor: Nobuhiro FUKUI, Hyogo (JP)

(73) Assignee: NORITZ CORPORATION, HYOGO (JP)

(21) Appl. No.: 17/785,052

(22) PCT Filed: Dec. 18, 2020
(86) PCT No.: PCT/JP2020/047460

§ 371 Date: Jun. 14, 2022

(30) Foreign Application Priority Data
Dec. 24, 2019 (JP) 2019-233408

(51) Int. Cl. F24H 9/02

(52) U.S. Cl. CPC F24H 9/02

(57) ABSTRACT

Provided is an exterior case for a hot-water unit, used to house hot-water equipment for generating or storing hot water inside, includes a thick printing portion that is provided on the outer surface of the exterior case and in which a plurality of inkjet printing layers are laminated in an overlaid state. It may be configured with thick printing portions that constitute Braille.

### TECHNICAL FIELD

The invention relates to a hot-water unit in which hot-water equipment for generating or storing hot water, such as a water heater or a cogeneration system, is housed in an exterior case, and the exterior case.

### RELATED ART

The applicant has previously proposed the ones described in Patent Documents 1 and 2 as specific examples of the exterior case for the hot-water unit.

The exterior cases for the hot-water unit described in these documents are, for example, formed by press-working color steel sheets having a paint layer provided on the outer surface of a metal plate. An inkjet printing layer is provided on the paint layer, and characters, symbols, figures, patterns, and so on (hereinafter, abbreviated as a design as appropriate) are displayed by the inkjet printing layer.

According to this configuration, by using an inkjet printer, it is possible to efficiently, rapidly, and easily represent a desired design on the surface of the exterior case and enhance the aesthetic properties. Compared with the conventional spray painting method, it is possible to improve the operating environment and greatly improve the productivity. The effect of reducing the manufacturing cost of the hot-water unit can also be obtained.

However, in the above-mentioned prior art, the inkjet printing layer is provided only as a single layer. Therefore, although a two-dimensional design can be represented by the inkjet printing layer, it is difficult to represent more (for example, three-dimensional representation). From the viewpoint of increasing the commercial value of the exterior case, it is desired to have functionality other than the flat design representation. In addition, the single-layer inkjet printing layer is susceptible to damage, and there is a risk of chalking occurring due to aging. Chalking is a phenomenon in which the pigment in the coating film is powdered and appears on the surface of the printing layer.

### CITATION LIST

### Patent Literature

Patent Literature 1: Japanese Patent Application Laid-Open No. 2019-60508

Patent Literature 2: Japanese Patent Application Laid-Open No. 2019-60509

### SUMMARY OF INVENTION

### Technical Problem

An object of the invention is to provide an exterior case for a hot-water unit capable of having unprecedented functionality aesthetic properties, and a hot-water unit equipped with the exterior case.

### Solution to Problem

In order to solve the above problems, the following technical means are taken in the invention.

The exterior case for a hot-water unit provided by a first aspect of the invention is an exterior case for a hot-water unit, used to house hot-water equipment for generating or storing hot water inside. The exterior case includes a thick printing portion that is provided on an outer surface of the exterior case and in which a plurality of inkjet printing layers are laminated in an overlaid state.

Preferably, the exterior case includes an exterior case body having an opening portion on at least one surface, and a cover body attached to the exterior case body so as to close the opening portion, and the thick printing portion is provided on an outer surface of at least one of the exterior case body and the cover body.

Preferably, an outermost layer of the inkjet printing layers of the thick printing portion is a clear layer.

Preferably, the exterior case has at least one of an exhaust port and an air supply port, and the exterior case includes a thick printing portion provided around the exhaust port or the air supply port as the thick printing portion.

Preferably, the exterior case includes a thick printing portion including a plurality of opaque inkjet printing layers containing pigments, and inkjet printing layers as clear layers located in between so as to separate the plurality of inkjet printing layers from each other in a printing thickness direction as the thick printing portion.

Preferably, the outer surface of the exterior case further includes an inkjet printing layer for design provided on the outer surface of the exterior case and representing at least one of letters, symbols, figures, or patterns.

Preferably, the exterior case includes a plurality of thick printing portions provided in a form of a plurality of dots separated from each other and constituting Braille as the thick printing portion.

The hot-water unit provided by a second aspect of the invention is characterized by including the exterior case for the hot-water unit provided by the first aspect of the invention.

Other features and advantages of the invention will become more apparent from the following description of embodiments of the invention with reference to the accompanying drawings.

### BRIEF DESCPRIPTION OF DRAWINGS

FIG. 1A is a side view showing an example of a hot-water unit according to the invention, and FIG. 1B is an exploded perspective view of the exterior case (in a state in which the internal hot-water equipment is omitted) of the hot-water unit shown in FIG. 1A.

FIG. 2A is a cross-sectional view of IIA-IIA of FIG. 1B, and FIG. 2B is a cross-sectional view of main parts showing another example for the configuration shown in FIG. 2A.

FIG. 3 is a cross-sectional view taken along a line III-III of FIG. 1B.

FIG. 4A is a cross-sectional perspective view of a partially broken portion of a third thick printing portion 4C shown in FIG. 1B, FIG. 4B is a sectional view taken along a line IVB-IVB of FIG. 4A, and FIGS. 4C and 4D are explanatory views of a part of the inkjet printing layers shown in FIG. 4B.

FIG. 5A is a cross-sectional perspective view of a partially broken portion showing another example of the third thick printing portion 4C shown in FIG. 1B, FIG. 5B is a cross-sectional view taken along a line VB-VB of FIG. 5A, and FIGS. 5C and 5D are explanatory views of a part of the inkjet printing layers shown in FIG. 5B.

FIGS. 6A to 6D are explanatory views showing an example of a step for manufacturing the cover body shown in FIG. 1B.

FIG. 7 is a cross-sectional view of main parts showing an example of a color steel sheet used for manufacturing the cover body shown in FIG. 1B.

FIG. 8A is a perspective view showing an example of a schematic configuration of a printer used for inkjet printing, and FIG. 8B is figure viewing from an arrow VIIIB of FIG. 8A, showing a schematic structure of the printhead of the printer shown in FIG. 8A.

FIG. 9 is a cross-sectional view of main parts showing an example of an operating step for obtaining the structure of FIG. 2A.

FIG. 10 is a perspective view showing another example of the invention.

FIG. 11 is a cross-sectional view taken along a line XI-XI of FIG. 10.

FIG. 12A is a perspective view showing another example of the invention, and FIG.

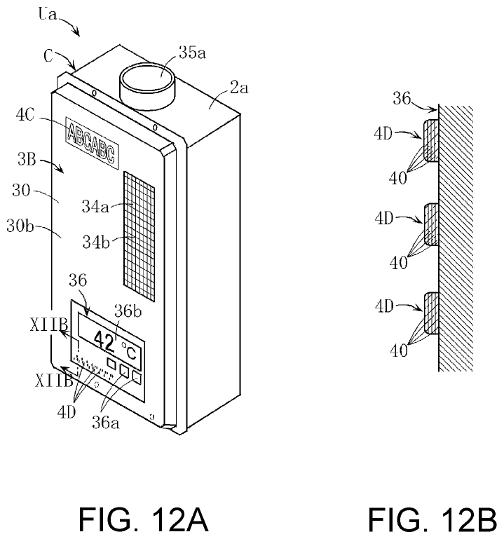

12B is a cross-sectional view taken along a line XIIB-XIIB of FIG. 12A.

### DESCRIPTION OF EMBODIMENTS

Hereinafter, preferred embodiments of the invention will be specifically described with reference to the drawings.

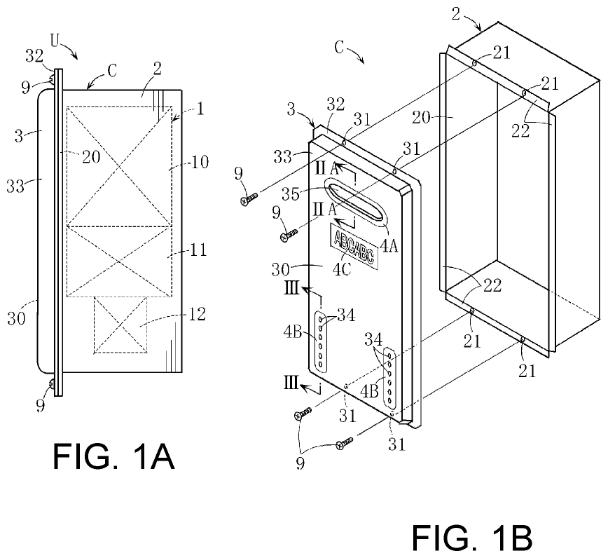

A hot-water unit U shown in FIGS. 1A and 1B is a water heater, and has a configuration in which hot-water equipment 1 for generating hot water is housed in an exterior case C. The hot-water equipment 1 includes a heat exchanger 10 through which hot water flows, a burner 11 for heating the hot water in the heat exchanger 10, a fan 12 for supplying combustion air to the burner 11, and the like.

The exterior case C includes a rectangular box-shaped case body 2 having an opening portion 20 on the front surface, and a cover body 3 (front cover body) that closes the opening portion 20. The cover body 3 is detachably attached to the front surface portion of the case body 2 by using, for example, screw bodies 9 such as screws and screw insertion holes 31 and 21 through which the screw bodies 9 are inserted.

In the present embodiment, the cover body 3 is provided with a first to a third thick printing portions 4A to 4C, which are not provided on the case body 2. Therefore, hereinafter, the configuration of the cover body 3 will be described in detail, and the description of the case body 2 will be omitted. However, as will be described later, it goes without saying that the case body 2 may be provided with the thick printing portion or the like.

The cover body 3 is formed by press-working a color steel sheet 30 to be described later, and has a panel shape having a substantially rectangular front view. The cover body 3 has an outer peripheral flange portion 32 and a bulging portion 33 that is surrounded by the outer peripheral flange portion 32 and that bulges forward (front side of the exterior case C) from the outer peripheral flange portion 32. The outer peripheral flange portion 32 is a portion for abutting on a flange portion 22 on the front surface portion of the case body 2. The bulging portion 33 is provided with a plurality of air supply ports 34 that allow outside air to flow into the exterior case C, and an exhaust port 35 for discharging the exhaust gas that has been heat-recovered by the heat exchanger 10 to the outside of the exterior case C.

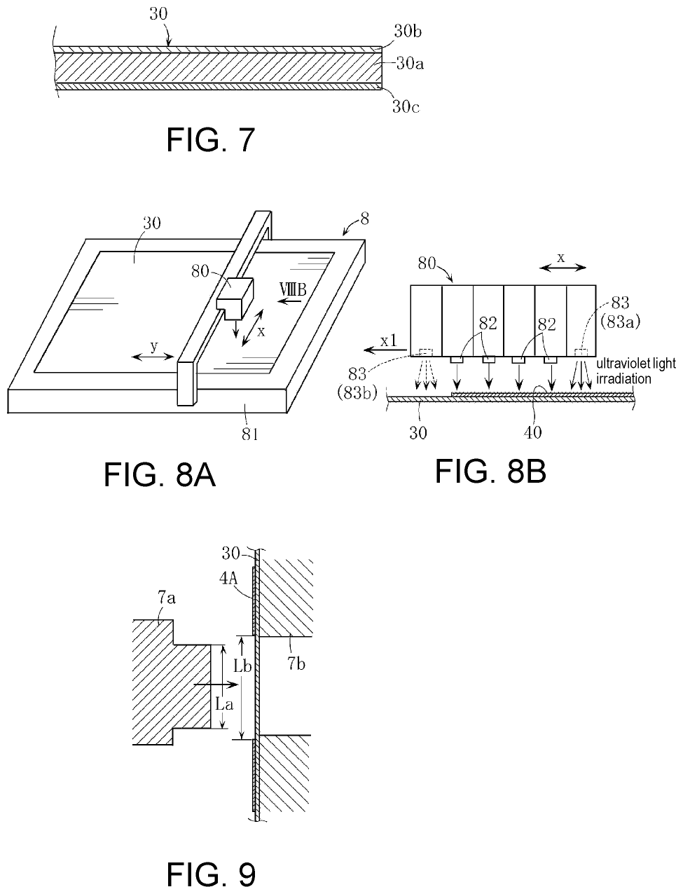

As shown in FIG. 7, the color steel sheet 30 has a multi-layer structure including a plated steel sheet 30a, a white-based (including white) front-side paint layer 30b laminated on the surface of the plated steel sheet 30a as an outer surface, and a back-side paint layer 30c on the back side as a service coat laminated on the back surface of the plated steel sheet 30a as an outer surface. The paint layer 30b is located on the surface side of the cover body 3, and the first to the third thick printing portions 4A to 4C are provided on the paint layer 30b.

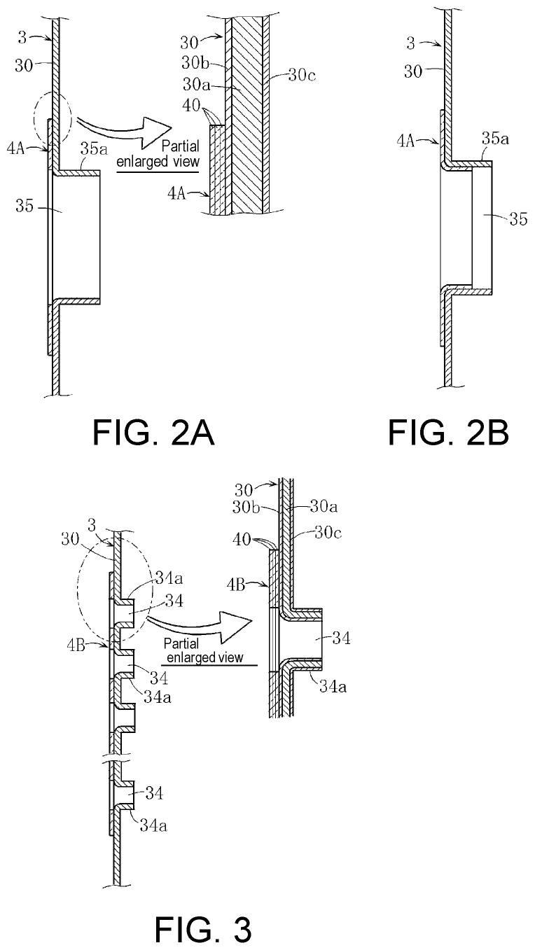

The first thick printing portion 4A is provided around the exhaust port 35, as well shown in FIG. 2A. The first thick printing portion 4A is a portion where a plurality of inkjet printing layers 40 are laminated in an overlaid state. These plurality of inkjet printing layers 40 are, for example, all clear layers and do not contain pigments. However, each of the inkjet printing layers 40, for example, contains an ultraviolet curable resin and a thermosetting resin (the same applies to a second and a third thick printing portions 4B and 4C, and thick printing portions 4D to be described later).

The exhaust port 35 is formed as a burring hole in which a cylindrical burring portion 35a is continuously provided on the back surface side of the peripheral portion thereof. The first thick printing portion 4A is not provided at a position facing the exhaust port 35 so as to avoid a corner portion of the burring portion 35a. This is preferable in order to prevent damage to the first thick printing portion 4A when the exhaust port 35 is formed after the formation of the first thick printing portion 4A, as will be described later. However, the invention is not limited thereto, and may have, for example, a configuration in which the first thick printing portion 4A is extended to the formation portion of the burring portion 35a, as shown in FIG. 2B.

As is well shown in FIG. 3, the second thick printing portion 4B is provided around the plurality of air supply ports 34. Similar to the first thick printing portion 4A, the second thick printing portion 4B is a portion where the plurality of inkjet printing layers 40 are laminated in an overlaid state. The plurality of inkjet printing layers 40 are all clear layers. Similar to the exhaust port 35, each air supply port 34 is also formed as a burring hole, and the second thick printing portion 4B is provided so as to avoid a burring portion 34a.

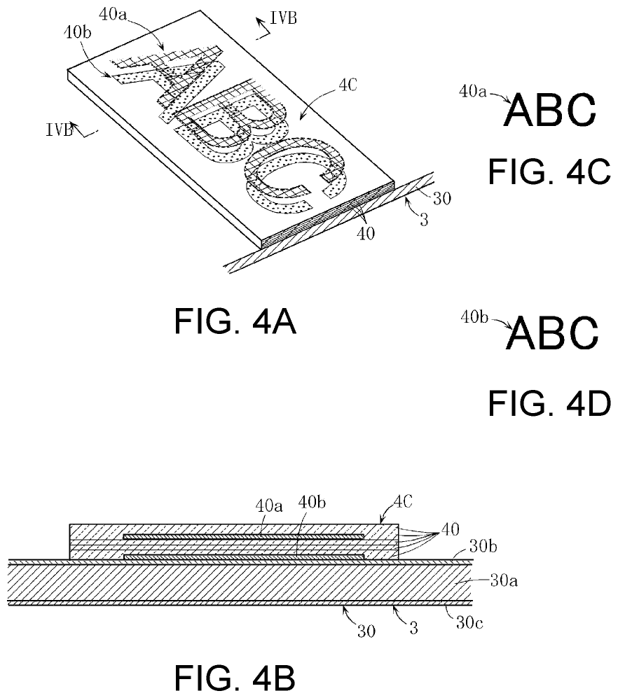

A third thick printing portion 4C represents characters such as the manufacturer, model, or trademark of the hot-water unit U (in the drawing, “ABCABC” as an example). The third thick printing portion 4C is composed of a plurality of inkjet printing layers 40 that overlap each other, as is well shown in FIGS. 4A to 4D (in the same figure, only “ABC” is represented).

However, a plurality of (for example, two) inkjet printing layers, 40a and 40b, forming a part thereof are opaque printing layers containing pigments. The inkjet printing layers 40 other than these (including the outermost layer of the inkjet printing layers 40) are clear layers. The opaque inkjet printing layers 40a and 40b represent, for example, the characters “ABC”, but the inkjet printing layers 40 as clear layers are interposed in between, and the opaque inkjet printing layers 40a and 40b are separated from each other in the print thickness direction. According to this configuration, when the third thick printing portion 4C is viewed from an angle, the characters “ABC” can be further seen behind the characters “ABC”, which gives the characters a three-dimensional effect.

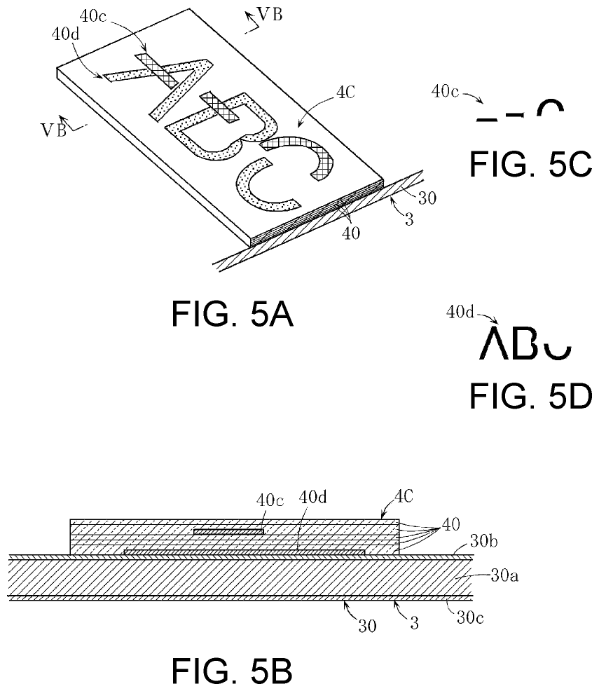

The third thick printing portion 4C may also be configured as shown in FIGS. 5A to 5D. In the configuration shown in the figures, one of two opaque inkjet printing layers 40c and 40d represents a part of the character “ABC”, and the other represents the remaining part of the character “ABC”. According to this configuration, since the characters are completed by combining the inkjet printing layers 40c and 40d, it is possible to give the characters a three-dimensional effect and adds fun.

The third thick printing portion 4C has been described as a specific example of displaying characters, but the invention is not limited thereto. The number and shape of the opaque inkjet printing layers similar to the inkjet printing layers 40a to 40d described above may be variously changed to represent characters other than the above-mentioned characters and other desired designs so as to give a three-dimensional effect.

The cover body 3 described above may be manufactured through the following steps.

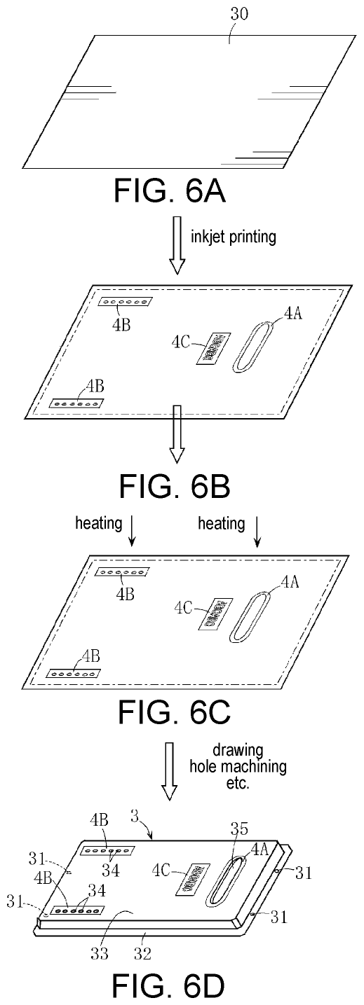

First, as shown in FIG. 6A, the flat plate-shaped color steel sheet 30 described with reference to FIG. 7 is prepared as a raw material for the cover body 3. Next, on the color steel sheet 30 (strictly speaking, on the paint layer 30b of the color steel sheet 30), inkjet printing is repeatedly performed a plurality of times. As a result, as shown in FIG. 6B, the first to the third thick printing portions 4A to 4C are provided.

Inkjet printing is performed using, for example, an inkjet printer 8 as shown in FIG. 8A. In the inkjet printer 8, a print head 80 is movable in the x and y directions orthogonal to each other on the upper side of a mounting table 81 on which the color steel sheet 30 is mounted and supported. As shown in FIG. 8B, the print head 80 includes a plurality of inkjet nozzles 82 for making inkjet paint of a predetermined color into droplets and sprayed the same onto the color steel sheet 30, and a pair of ultraviolet light sources 83 (83a, 83b).

For example, when performing inkjet printing while moving the print head 80 in an x1 direction of FIG. 8B as the main scanning direction, the ultraviolet light source 83a on the rear side in the main scanning direction is made to emit light, and the area immediately after inkjet printing is irradiated with ultraviolet light. Since the inkjet printing layer 40 contains an ultraviolet curable resin, the inkjet printing layer 40 can be rapidly cured (cured to the extent that bleeding does not occur) by irradiation with the ultraviolet light described above. When such a curing process is completed, the inkjet printing is performed again, and the inkjet printing and the curing process are repeated to form (overlay) a plurality of inkjet printing layers 40 in a laminated manner. When the inkjet printing is carried out in a direction opposite to the x1 direction described above, the same effect as described above can be obtained by making the ultraviolet light source 83b to emit light instead of the ultraviolet light source 83a.

After finishing the above-mentioned inkjet printing on the color steel sheet 30, as shown in FIG. 6C, the color steel sheet 30 is heated to dry the first to the third thick printing portions 4A to 4C, and the thermosetting resin contained therin is cured. As a result, it is possible to increase the strength of the first to the third thick printing portions 4A to 4C, and make them have durability against the press-working performed thereafter.

After the thermosetting treatment described above, drawing as a press-working is performed on the color steel sheet 30 to form the outer peripheral flange portion 32 and the bulging portion 33 as shown in FIG. 6D. Along with this, press-working for forming the air supply port 34, the exhaust port 35 and the like; and trimming processing for removing the excess portion of the outer peripheral flange portion 32 and the like are performed. Thereby, the cover body 3 described above can be manufactured.

The operation of forming the exhaust port 35 is performed by using a punch 7a and a die 7b, for example, as shown in FIG. 9. In this case, the first thick printing portion 4A is provided so as to avoid the place where the exhaust port 35 is planned to be formed, and is provided with a non-printing portion having a width Lb larger than a width La of the punch 7a. According to such means, the possibility that the first thick printing portion 4A is damaged due to the contact with the punch 7a can be eliminated. This is the same for the second thick printing portion 4B.

Next, the operations of the exterior case C provided with the cover body 3 and the hot-water unit U will be described.

First, the surrounding of the exhaust port 35 may be heated by the exhaust gas and become hot. Therefore, of the paint layer 30b of the color steel sheet 30 constituting the cover body 3, the surroudingl portion of the exhaust port 35 is inherently liable to deteriorate. Further, since surrouding of the air supply port 34 is also subject to drippings and the like, the surrouding portion portion of the air supply port 34 of the paint layer 30b is inherently liable to deteriorate. On the other hand, since the first and the second thick printing portions 4A and 4B are respectively provided around the exhaust port 35 and the air supply port 34, the paint layer 30b is protected, and the above-mentioned risk is appropriately eliminated. The first and the second thick printing portions 4A and 4B are large in thickness and durable, and are less likely to be damaged as compared with the paint layer 30b. Therefore, the durability of the outer surface coating of the cover body 3 can be improved.

The plurality of inkjet printing layers 40 constituting the first and the second thick printing portions 4A and 4B are all clear layers containing no pigments. Therefore, the occurrence of chalking is also appropriately prevented.

Further, as described with reference to FIGS. 4A to 4D and FIGS. 5A to 5D, since the third thick printing portion 4C can represent three-dimensional characters, it is useful for enhancing the aesthetic properties or decoration of the hot-water unit U. Since the outermost layer of the inkjet printing layers 40 of the third thick printing portion 4C is a clear layer, the occurrence of chalking in the third thick printing portion 4C can also be appropriately prevented. In other words, since the clear layer does not contain pigments and does not cause chalking, if the clear layer is provided on the outermost layer of the third thick printing portion 4C, the occurrence of chalking in the third thick printing portion 4C due to aging can be appropriately prevented.

As can be understood from the above-described embodiment, since the thick printing portion in the invention has a configuration in which a plurality of inkjet printing layers are laminated in an overlaid state, the thickness can be increased and representations that are difficult to represent (for example, a three-dimensional representation) can be enabled with only a single inkjet printing layer. Moreover, compared to a single inkjet printing layer, the thick printing portion can be made stronger and less susceptible to damage due to its larger thickness, and can be made less likely to deteriorate over time. Further, since the thick printing portion can be formed by repeatedly performing the inkjet printing a plurality of times, the forming operation is easy and it is possible to prevent the manufacturing cost of the exterior case from being significantly increased.

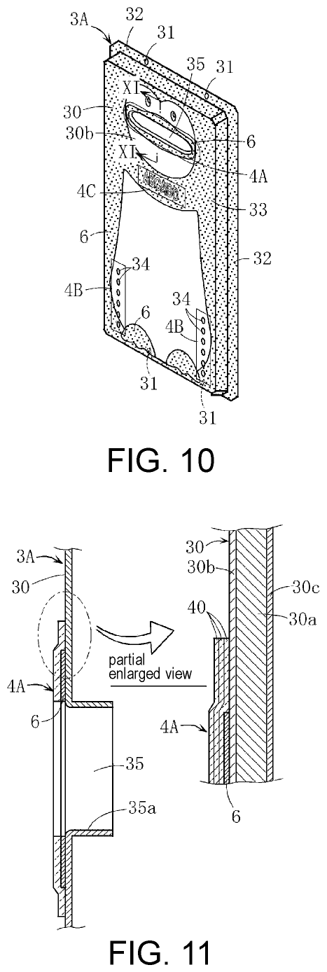

FIGS. 10 to 12B show other embodiments of the invention. In these figures, the same or similar elements as those in the above-mentioned embodiment are designated by the same reference numerals as those in the above-mentioned embodiment, and redundant descriptions will be omitted.

In a cover body 3A shown in FIG. 10, a plurality of opaque inkjet printing layers 6 (corresponding to an example of the inkjet printing layer for design in the invention) representing, for example, a penguins design are provided on the front surface portion (on the paint layer 30b) of the cover body 3A. The white portion of the cover body 3A in FIG. 10 is a portion of the paint layer 30b of the color steel sheet 30 that has not been subjected to inkjet printing. The first to the third thick printing portions 4A to 4C are provided in a state of being overlapped on the inkjet printing layers 6.

More specifically, as shown in FIG. 11, the inkjet printing layers 6 representing a design is provided around the exhaust port 35. The first thick printing portion 4A is further overlapped on the inkjet printing layers 6. This configuration is the same for the second and the third thick printing portions 4B and 4C.

According to the present embodiment, since the design is represented by the plurality of inkjet printing layers 6, the aesthetic properties can be improved as compared with the cover body 3 described above. The plurality of inkjet printing layers 6 (inkjet printing layer for design referred to in the invention) can represent not only the designs as described above, but also a variety of other characters, symbols, figures, or patterns.

A hot-water unit Ua shown in FIG. 12A is an indoor installation type. A cover body 3B of the hot-water unit Ua is provided with an air supply port 34a to which a filter 34b is attached and an operation panel portion 36. The exhaust port 35a is provided on the upper part of a case body 2a.

The operation panel portion 36 is configured as a device separate from the color steel sheet 30 constituting the main body portion of the cover body 3B, and is assembled to the main body portion as a part of the cover body 3B. The operation panel portion 36 is further provided with a plurality of thick printing portions 4D in addition to operation switches 36a for performing various settings such as hot water temperature, and a display portion 36b composed of a liquid crystal display or a 7-segment display for displaying a screen such as hot water temperature.

The plurality of thick printing portions 4D are provided in a form of a plurality of dots separated from each other to constitute Braille. More specifically, as shown in FIG. 12B, each the thick printing portion 4D is a columnar small protrusion having a plurality of inkjet printing layers 40 laminated and, for example, having a height of about 0.3 to 0.5 mm and a diameter of about 1.4 mm. The plurality of inkjet printing layers 40 of each thick printing portion 4D are opaque inkjet printing layers containing pigments, and the colors thereof are, for example, the same as those of the front surface portion of the operation panel portion 36. However, preferably, the outermost layer of the inkjet printing layers 40 is a clear layer to prevent chalking. Of course the plurality of inkjet printing layers 40 may be clear layers.

The plurality of thick printing portions 4D correspond to Braille displaying desired items such as “contact information when a problem occurs in the hot-water unit Ua” or “notes regarding the hot-water unit Ua”. These plurality of thick printing portions 4D are provided, for example, by performing inkjet printing on the operation panel portion 36 at a stage before the operation panel portion 36 is assembled as a part of the cover body 3B. However, the invention is not limited thereto, and the thick priting portions 4D may be provided after the operation panel portion 36 is assembled as a part of the cover body 3B.

According to the present embodiment, since the desired items are displayed in Braille using the thick printing portions 4D, the printing unit can be made user-friendly. As another means for providing Braille, for example, a plate provided with Braille may be attached to the exterior case C, but this may cause the plate to peel off and fall off. On the other hand, according to the present embodiment, there is no such risk. In addition, unlike the present embodiment, the thick printing portion similar to the thick printing portions 4D may be provided in another part of the cover body 3B or the case body 2a instead of the operation panel portion 36.

The invention is not limited to the contents of the above-described embodiments. The exterior case for the hot-water unit according to the invention and the specific configuration of each part of the hot-water unit can be variously redesigned within the scope of the invention.

In the above-described embodiment, for example, the first to the third thick printing portions 4A to 4C show an example provided on the paint layer 30b on the surface side of the cover body 3, but the invention is not limited thereto. The thick printing portion referred to in the invention may have a configuration provided on the paint layer 30c on the back surface side of the cover body 3, or may have a configuration provided on the case body 2.

The thick printing portion referred to in the invention is a portion where a plurality of inkjet printing layers are laminated in an overlaid state. The specific number, size, presence/absence of pigment (whether or not a clear layer), and the like of the plurality of inkjet printing layers constituting the thick printing portion are not limited. In order to prevent chalking, it is preferable that at least the outermost layer of the inkjet printing layers is a clear layer, but not limited thereto. When an inkjet printing layer different from the thick printing portion (for example, the inkjet printing layer 6 in FIG. 10) is provided, it does not matter whether the thick printing portion is laminated on the upper side of such an inkjet printing layer.

The specific position where the thick printing portion referred to in the invention is provided is not limited. For example, it can be provided around the screw fastening place of the exterior case. If rust occurs on the screw around the screw fastening place, drippings containing the rust may contaminate the area around the screw fastening palce and cause damage. In order to suppress such a situation, the thick printing portion may be provided around the screwed portion.

The hot-water unit according to the invention may also be configured as a hot water storage tank unit in which hot-water equipment for storing hot water such as a hot water storage tank is housed in the exterior case, instead of having hot-water equipment such as a water heater housed in the exterior case. Therefore, the exterior case is not limited to a combination of a case body having an opening portion on the front surface and a cover body that closes the front opening portion. A metal plate is generally used as the material of the exterior case, but a metal plate different from the commercially available color steel sheet may be used.

What is claimed is:

1. An exterior case for a hot-water unit, used to house hot-water equipment for generating or storing hot water inside, the exterior case comprising:
a thick printing portion that is provided on an outer surface of the exterior case and in which a plurality of inkjet printing layers are laminated in an overlaid state.

2. The exterior case for a hot-water unit according to claim 1,
wherein the exterior case comprises an exterior case body having an opening portion on at least one surface, and a cover body attached to the exterior case body so as to close the opening portion, and
the thick printing portion is provided on an outer surface of at least one of the exterior case body and the cover body.

3. The exterior case for a hot-water unit according to claim 1,
wherein an outermost layer of the inkjet printing layers of the thick printing portion is a clear layer.

4. The exterior case for a hot-water unit according to claim 1,
wherein the exterior case has at least one of an exhaust port and an air supply port, and
the exterior case comprising a thick printing portion provided around the exhaust port or the air supply port as the thick printing portion.

5. The exterior case for a hot-water unit according to claim 1, comprising:
a thick printing portion comprising a plurality of opaque inkjet printing layers containing pigments, and inkjet printing layers as clear layers located in between so as to separate the plurality of inkjet printing layers from each other in a printing thickness direction as the thick printing portion.

6. The exterior case for a hot-water unit according to claim 1, further comprising:
an inkjet printing layer for design provided on the outer surface of the exterior case and representing at least one of characters, symbols, figures, or patterns.

7. The exterior case for a hot-water unit according to claim 1, comprising:
a plurality of thick printing portions provided in a form of a plurality of dots separated from each other and constituting Braille as the thick printing portion.

8. A hot-water unit, comprising:
the exterior case for the hot-water unit according to claim 1.
